(19) United States
(12) Patent Application Publication
(10) Pub. No.: US 2026/0238328 A1
(43) Pub. Date: Aug. 13, 2026

(54) METHODS AND APPARATUS FOR ADAPTATION OF NON-TERRESTRIAL NETWORK PROCEDURES FOR AN AIR-TO-GROUND NETWORKS IN A WIRELESS COMMUNICATION SYSTEM

(71) Applicant: Samsung Electronics Co., Ltd., Gyeonggi-do (KR)

(72) Inventors: Jonas SEDIN, Middlesex (GB); Chadi KHIRALLAH, Middlesex (GB)

(21) Appl. No.: 19/472,947

(22) PCT Filed: Apr. 2, 2024
(86) PCT No.: PCT/KR2024/004231

§ 371 Date: Oct. 6, 2025

(30) Foreign Application Priority Data
Apr. 6, 2023 (GB) 2305224.4
Aug. 9, 2023 (GB) 2312216.1
Feb. 21, 2024 (GB) 2402464.8

(51) Int. Cl. H04B 7/185

(52) U.S. Cl. CPC H04B 7/18502

(57) ABSTRACT

The disclosure relates to a 5G or 6G communication system for supporting a higher data transmission rate. A user equipment (UE) for performing air-to-ground (ATG) communications with a base station, the UE comprising a transmitter, a receiver, and a controller, wherein the controller is configured to control the receiver to receive system information from the base station, the system information including a reference location of the base station and a height associated with the base station; determine a position of the UE relative to the base station based on the reference location of the base station and a height associated with the base station; and perform an event based on the UE's location relative to the base station.

### TECHNICAL FIELD

Certain examples of the present disclosure provide approaches for adapting Non-Terrestrial Network (NTN) procedures to Air-To-Ground (ATG) networks. For example, certain examples of the present disclosure provide methods, apparatus and systems for implementing NTN procedures in ATG networks in 3rd Generation Partnership Project (3GPP) networks such as 5th Generation (5G) and 6th Generation (6G) networks.

### BACKGROUND ART

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultrahigh-performance communication and computing resources.

### DISCLOSURE OF INVENTION

### Technical Problem

The present disclosure relates to wireless communication systems and, more specifically, the present disclosure relates to adaptation for non-terrestrial network procedure for an air-to-ground networks in a wireless communication.

### Solution to Problem

It is an aim of certain examples of the present disclosure to address, solve and/or mitigate, at least partly, at least one of the problems and/or disadvantages associated with the related art, for example at least one of the problems and/or disadvantages described herein. It is an aim of certain examples of the present disclosure to provide at least one advantage over the related art, for example at least one of the advantages described herein.

Adaptations provided by the present disclosure to address the aforementioned shortcomings include:
Uplink sync validity duration operation by not operating the uplink sync validity timer (T430).
Not including/ignoring certain fields of SIB19
Adaptations related to location signalling and location reporting
Adaptations related to capabilities that are not needed for ATG
Discontinuous coverage adaptations.
Adaptations related to AS security and base station location

In accordance with one aspect of the present disclosure, there is provided a user equipment (UE) for performing air-to-ground (ATG) communications with a base station, the UE comprising a transmitter, a receiver, and a controller, wherein the controller is configured to control the receiver to receive system information from the base station, the system information including a reference location of the base station and a height associated with the base station; determine a position of the UE relative to the base station based on the reference location of the base station and a height associated with the base station; and perform an event based on the UE's location relative to the base station.

In an example, the system information includes a height associated with a neighbouring base station.

In an example, the reference location defines a location based on a latitude and a longitude.

In an example, the event is a cell reselection event, a synchronization event, a measurement report event, or a location report.

In an example, the controller is configured to determine a 3D distance between the UE and the base station based on the reference location of the base station and a height associated with the base station.

In an example, the controller is configured to transit information associated with the event to the base station.

In an example, the information associated with the event includes one or more of a 3D distance between the UE and the base station, a height of the UE, and a velocity of the UE.

In an example, the UE's location relative to the base station is with respect to a distance threshold from a reference position of the base station, where the reference position is based on the reference location of the base station and the height associated with the base station.

In accordance with one aspect of the present disclosure, there is provided a method for a User Equipment (UE) for performing air-to-ground communications with a base station, the method comprising: receiving system information from the base station, the system information including a reference location of the base station and a height associated with the base station; determining a position of the UE relative to the base station based on the reference location of the base station and a height associated with the base station; and performing an event based on the UE's location relative to the base station.

In an example, the system information includes a height associated with a neighbouring base station.

In an example, the reference location defines a location based on a latitude and a longitude.

In an example, the event is a cell reselection event, a synchronization event, a measurement report event, or a location report.

In an example, the method further comprises determining a 3D distance between the UE and the base station based on the reference location of the base station and a height associated with the base station.

In an example, the method further comprises transmitting information associated with the event to the base station.

In an example, the information associated with the event includes one or more of a 3D distance between the UE and the base station, a height of the UE, and a velocity of the UE.

In an example, the UE's location relative to the base station is with respect to a distance threshold from a reference position of the base station, where the reference position is based on the reference location of the base station and the height associated with the base station.

In accordance with one aspect of the present disclosure, there is provided a base station for performing air-to-ground (ATG) communications with a user equipment (UE), the base station comprising a transmitter, a receiver, and a controller, wherein the controller is configured to control the transmitter to broadcast system information including a reference location of the base station and a height associated with the base station; and control the receiver to receive, from the UE, information associated with an event that has been performed by the UE based on the reference location of the base station and a height associated with the base station.

In an example, the system information includes a height associated with a neighbouring base station.

In an example, the reference location defines a location based on a latitude and a longitude.

In an example, the event is a cell reselection event, a synchronization event, a measurement report event, or a location report.

In an example, the information associated with the event includes one or more of a 3D distance between the UE and the base station, a height of the UE, and a velocity of the UE.

In accordance with one aspect of the present disclosure, there is provided a method for a base station for performing air-to-ground (ATG) communications with a user equipment, the method comprising: broadcasting system information including a reference location of the base station and a height associated with the base station; and receiving, from the UE, information associated with an event that has been performed by the UE based on the reference location of the base station and a height associated with the base station.

In accordance with one aspect of the present disclosure, there is provided a method for an air-to-ground (ATG) communications system comprising a base station and a User Equipment (UE), the method comprising: broadcasting, by the base station, system information including a reference location of the base station and a height associated with the base station; receiving, by the UE, the system information; determining, by the UE, a position of the UE relative to the base station based on the reference location of the base station and a height associated with the base station; and performing, by the UE, an event based on the UE's location relative to the base station.

In accordance with one aspect of the present disclosure, there is provided a method performed by a user equipment (UE) in a wireless communication system, the method comprising: receiving, from a base station, a system information message including at least one system information block (SIB); and identifying an air-to-ground (ATG) configuration based on an SIB of the at least one SIB; and performing an ATG access procedure based on the ATG configuration.

In accordance with one aspect of the present disclosure, there is provided a method performed by a base station in a wireless communication system, the method comprising: identifying an air-to-ground (ATG) configuration based on a system information block (SIB); and transmitting, to a user equipment (UE), a system information message including the SIB; wherein an ATG access procedure is performed based on the ATG configuration.

In accordance with one aspect of the present disclosure, there is provided a user equipment (UE) in a wireless communication system, the UE comprising: a transceiver; and a controller coupled with the transceiver configured to: receive, from a base station, a system information message including at least one system information block (SIB); and identify an air-to-ground (ATG) configuration based on an SIB of the at least one SIB; and
perform an ATG access procedure based on the ATG configuration.

In accordance with one aspect of the present disclosure, there is provided a base station in a wireless communication system, the base station comprising: a transceiver; and a controller coupled with the transceiver configured to: identify an air-to-ground (ATG) configuration based on a system information block (SIB); and transmit, to a user equipment (UE), a system information message including the SIB; wherein an ATG access procedure is performed based on the ATG configuration.

Other aspects, advantages, and salient features of the disclosure will become apparent to those skilled in the art from the following detailed description taken in conjunction with the accompanying drawings.

### Advantageous Effects of Invention

According to an embodiment of the disclosure, a wireless communication can be performed efficiently. Especially, a adapting a non-terrestrial network process for an air-to-ground network can be performed efficiently.

### BRIEF DESCRIPTION OF DRAWINGS

Embodiments/examples of the present disclosure are further described hereinafter with reference to the accompanying drawings, in which:

FIG. 1 provides a diagram of an example non-terrestrial network (NTN);

FIG. 2 provides a diagram of an example air-to-ground (ATG) network;

FIG. 3 provides an illustrative example of a New Radio (NR) NTN uplink sync validity operation;

FIG. 4 provides an example of a ephemeris synchronization operation in Internet of Things (IoT) NTN, where in a) SIB31 functions as normal and b) where UE fails to read SIB31 during T318 which then expires and triggers RLF;

FIG. 5 provides a diagram illustrating an example of discontinuous coverage in a NTN;

FIG. 6a provides an example of a UE sending coarse UE location information;

FIG. 6b provides an example of an access stratum (AS) security procedure;

FIG. 7 provides an example ATG network where an ATG cell gNB is broadcasting SIB19 with the ephemeris broadcasting the position and with the velocity-component being 0;

FIG. 8 provides an example in which the reference location altitude is the same for both reference locations, b) reference location being different for the reference locations;

FIG. 9 provides an example where an ATG UE first acquires a coarse base station location and updates the base station location after AS security is established;

FIG. 10 provides an example of an ATG UE receiving an ATG correction vector or full location in a terrestrial network before connecting to an ATG network; and

FIG. 11 provides a block diagram of an exemplary network entity/function that may be used in certain examples of the present disclosure.

### MODE FOR THE INVENTION

The content of the following documents is referred to below and/or their content provides background information and context that the following disclosure should be considered in view of:
3GPP TS 36.304 V17.2.0 September 2022.
GPP TS 38.331 V17.3.0 January 2023
GPP TS 36.331 V17.4.0 March 2023
GPP TS 36.304 V17.4.0 March 2023
GPP TS 38.304 V17.4.0 March 2023
3GPP TS 38.331 V17.4.0 March 2023
GPP TS 38.306 V17.4.0 March 2023
3GPP TS 37.355 V17.4.0 March 2023
RP-211557 3GPP TSG RAN meeting #91-e e-meeting, Mar. 22-26, 2021
RP-202689 3GPP TSG RAN Meeting #90 Electronic Meeting, Dec. 7-11, 2020
RP-211557 3GPP TSG RAN meeting #91-e e-meeting, Mar. 22-26, 2021
RP-220953 3GPP TSG RAN Meeting #95e Electronic Meeting, Mar. 17-23, 2022
RP-220979 3GPP TSG RAN Meeting #95e Electronic Meeting, Mar. 17-23, 2022
RP-222654 3GPP TSG RAN Meeting #97-e e-meeting, Sep. 12-16, 2022
RP-221369 3GPP TSG RAN Meeting #96 Budapest, Hungary, Jun. 6-9, 2022
LS R2-2302016 3GPP TSG-RAN WG2 Meeting #121 Athens, Greece, Feb. 27-Mar. 3, 2023
R4-2303684 3GPP TSG-RAN WG4 Meeting #106 Athens, Greece, Feb. 27-Mar. 3, 2022
R4-2300081 3GPP TSG-RAN WG4 Meeting #106 Athens, Greece, Feb. 27-Mar. 3, 2022
(Note: the example versions shown for each TS are non-limiting, other versions of the TS may be considered also)

Wireless or mobile (cellular) communications networks in which a mobile terminal (e.g., user equipment (UE), such as a mobile handset) communicates via a radio link with a network of base stations, or other wireless access points or nodes, have undergone rapid development through a number of generations. The 3rd Generation Partnership Project (3GPP) design, specify and standardise technologies for mobile wireless communication networks. Fourth Generation (4G) and Fifth Generation (5G) systems are now widely deployed, and development of Sixth Generation (6G) Systems is in progress.

GPP standards for 4G systems include an Evolved Packet Core (EPC) and an Enhanced-UTRAN (E-UTRAN: an Enhanced Universal Terrestrial Radio Access Network). The E-UTRAN uses Long Term Evolution (LTE) radio technology. LTE is commonly used to refer to the whole system including both the EPC and the E-UTRAN, and LTE is used in this sense in the remainder of this document. LTE should also be taken to include LTE enhancements such as LTE Advanced and LTE Pro, which offer enhanced data rates compared to LTE.

In 5G systems a new air interface has been developed, which may be referred to as 5G New Radio (5G NR) or simply NR. NR is designed to support the wide variety of services and use case scenarios envisaged for 5G networks, though builds upon established LTE technologies. New frameworks and architectures are also being developed as part of 5G networks in order to increase the range of functionality and use cases available through 5G networks.

In recent years, Non-Terrestrial Network (NTN) and Air-To-Ground (ATG) networks have been considered and their operation integrated into 3GPP systems in order to enhance coverage and/or provide alternative coverage mechanisms.

### Non-Terrestrial Networks (NTNs)

NR NTN (NR_NTN_solutions-Core) [RP-211557] was a 3GPP Work Item in 3GPP Release 17 to define solutions to enable New Radio (NR) and NG-RAN to support NTN. It addressed solutions for transparent payload for both Geostationary and non-Geostationary network scenarios, with the UE having Global Navigation Satellite System (GNSS) capability and the satellite beams being both earth-fixed or earth-moving.

Internet of Things (IoT) NTN was a 3GPP study and work item in 3GPP release 17 to provide NTN access for E-UTRAN IoT devices (NB-IoT and LTE-M/eMTC) [RP-202689]. NR NTN was a work item in Rel-17 to specify adaptation to allow NR to function over NTN [RP-211557]. NTN access may be through Lower Earth Orbit (LEO), Medium Earth Orbit (MEO) and Geostationary Orbit (GEO), as well as through High-Altitude Platform Systems (HAPS).

Following the Work items in Release 17 there were work items to enhance NR NTN [RP-220953] and IoT NTN [RP-220979] in Release 18.

NR NTN enhancements [RP-222654] is a 3GPP Work Item in 3GPP Release 18 aiming to enhance NR NTN with the following topics:
Coverage Enhancements
Identifying and specifying potential issues and enhancements considering NTN characteristics
NR NTN Deployment in Above 10 GHz Bands
NR NTN Release 17 did not have support for FR2 due to there being no PRACH format in FR2 for FDD.
Network Verified UE Location
NTN-TN and NTN-NTN Mobility and Service Continuity Enhancements
Considers NTN-TN and NTN-NTN measurement/mobility and service continuity enhancements

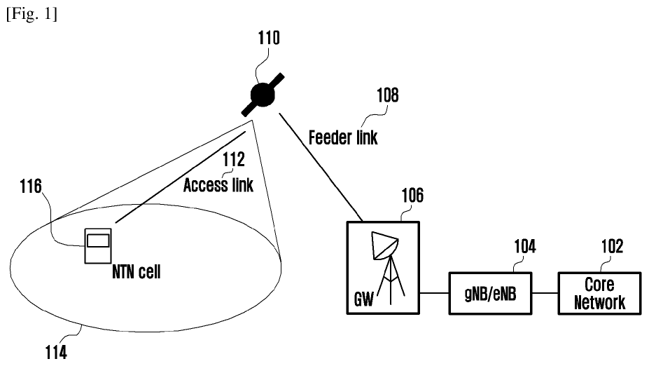

FIG. 1 provides an illustration of an example NTN where a gateway (GW) 106 provides a feeder link 108 to a satellite 110 and the satellite provides an NTN cell 114 and an access link 116 to a device, such as a UE, within the NTN cell. The gateway may be connected to a gNB/eNB 104 which in turn is connected to a core network 102. The gateway 106 may be part of the gNB/eNB 104, separate to or partially integrated. Some of the functions of the gNB/eNB may also be implemented in the satellite 110 in some examples.

### Air-To-Ground Networks

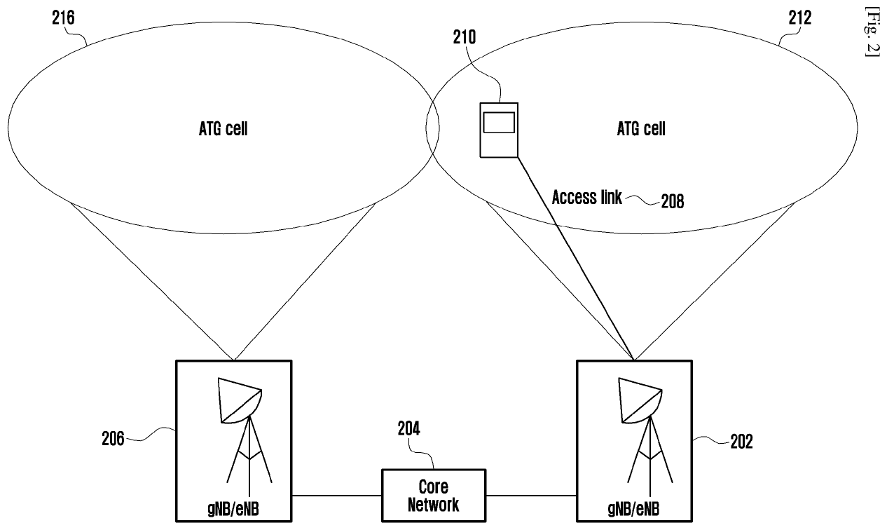

An Air-To-Ground (abbreviated as ATG or A2G) network is a cellular network that provides connectivity in the air via base stations (BS) on the ground. It is different from a NTN as the access link is from the ground to the UE in the sky, where as in NTN the access link is from space/sky to the ground, as seen in FIG. 2 which provides an illustration of an example ATG network. In FIG. 2, gNBs/eNBs 202 and 206 provide ATG cells 212 and 216 and are connected to a core network 204. gNB/eNB 202 provides an access link 208 to device 210 that is within ATG cell 212. One of the main the use cases of A2G network is to provide backhaul connectivity to access points in aircraft.

A Study item was started in Rel-18 [RP-221369] in RAN4 to define requirements for coexistence between ATG and International Mobile Telecommunications (IMT) terrestrial networks. Furthermore to define Radio Resource Management (RRM) performance requirements for ATG UEs, demodulation performance requirements for ATH BS/UE, and test procedures for ATG BS conformance testing.

The ATG network is similar to a NTN in the sense that the cells can be very large, synchronization will have to be different and that there are network elements that may move very quickly.

Some of the characteristics from an Radio Frequency (RF) point of view of an ATG network are spelled out in [RP-221369]:
Extremely large inter-site distances and large coverage range
Utilizing non-disjoint frequency for deploying both ATG and terrestrial networks
Much more powerful on-board ATG terminal capacity

### Synchronization Operation in Non-Terrestrial Networks

Synchronization in NR NTN is partly achieved by the UE computing the distance between the UE and the NTN node. To do this the UE needs to know its own position as well as the position of the satellite. A UE acquires its own position through GNSS and the satellite position through what is known as satellite ephemeris element broadcasted in System Information (SI). As both the UE and satellite may move, this is maintained in two ways, through 1) maintaining an accurate GNSS position, 2) maintaining a recent ephemeris element of the serving satellite.

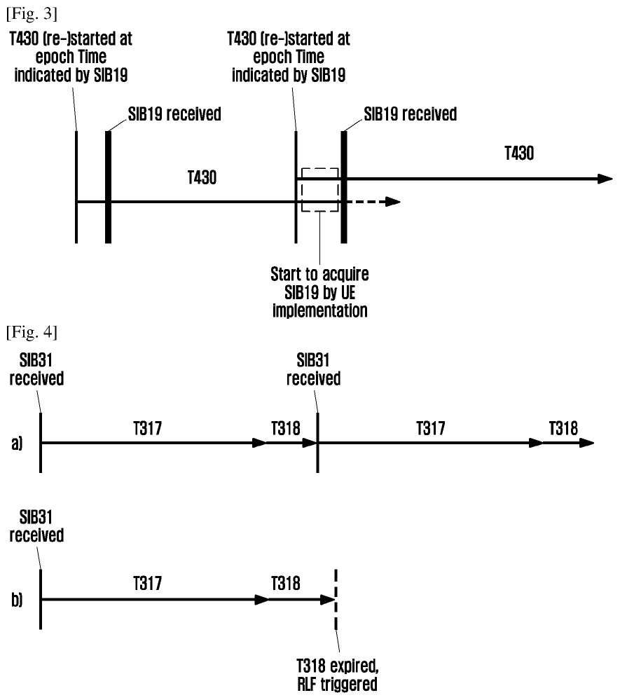

In NR NTN, the operation is somewhat different compared to IoT NTN due to the different capabilities of an NR NTN UE. An NR UE is considered to be a lot more capable in terms of performing multiple actions simultaneously. Thus an NR NTN UE will read system information before the end of the uplink synchronization timer (timer T430), without the need for a separate timer to start if UE fails to read the SIB19. This can be seen in the specification 38.331 V17.3.0 below and in FIG. 3, which illustrates the T430 timer in relation to SIB19 i.e. NR NTN uplink sync validity operation.

| | |
|---|---|
| 5.2.2.4.21 | Actions upon reception of SIB19 |

Upon receiving SIB19, the UE shall:

| | |
|---|---|
| 1> | start or restart T430 for serving cell with the timer value set to ntn-UlSyncValidityDuration from the |
| | subframe indicated by epochTime; |

5.2.2.6 T430 expiry
The UE shall:

| 1> | if T430 for serving cell expires and if in RRC_CONNECTED: | |
|---|---|---|
| | 2> | inform lower layers that UL synchronisation is lost; |
| | 2> | acquire SIB19 as defined in clause 5.2.2.3.2; |
| | 2> | upon successful acquisition of SIB19: |
| | | 3> inform lower layers that UL synchronisation is obtained; |

In IoT NTN the serving cell ephemeris element is sent in system information in an element known as SIB31 and in order to make sure that the UE is correctly synchronized, this element needs to be read every time it connects to an IoT NTN eNB. There is furthermore a timer (T317) associated with the ephemeris element that is started every time SIB31 is read and at expiry the UE is no longer considered synchronized and it will have to re-acquire SIB31 in order to stay synchronized. In NR NTN, the UE shall ensure that it has a recent ephemeris (SIB19 in NR) by reading the SIB in time by UE implementation. In IoT NTN, since an IoT UE (LTE-M and NB-IoT UE) is not expected to be able to receive system information in connected mode, the UE tunes away and is likely unreachable while reading SIB31. If the IoT NTN UE is unable to read the SIB31 within a timer (T318) with a configured duration, the UE performs RLF similar to other cases where Radio Link Failure (RLF) is performed. This operation can be seen in the specification below (36.331 V17.4.0) and FIG. 4, which illustrates the T317 and T318 timers in relation to SIB31. In particular, FIG. 4 shows ephemeris synchronization operation in IoT NTN, where in a) SIB31 functions as normal and b) where UE fails to read SIB31 during T318 which then expires and triggers RLF.

| | |
|---|---|
| 5.2.2.39 | Actions upon reception of SystemInformationBlockType31 |

Upon receiving SystemInformationBlockType31 (SystemInformationBlockType31-NB), the UE shall:

| | |
|---|---|
| 1> | start or restart timer T317 with the duration ul-SyncValidityDuration from the subframe indicated by |
| | epochTime. |

| | |
|---|---|
| 5.3.18 | T317 expiry |

The UE shall:

| 1> | if in RRC_CONNECTED: | |
|---|---|---|
| | 2> | inform lower layers that the UL synchronisation is lost; |
| | 2> | start timer T318; |
| | 2> | acquire SystemInformationBlockType31 (SystemInformationBlockType31-NB in NB-IoT) as specified |
| | | in 5.2.2; |
| | 2> | upon successful acquisition of SystemInformationBlockType31 (SystemInformationBlockType31-NB |

| in NB-IoT): | |
|---|---|
| 3> | stop timer T318; |
| 3> | inform lower layers when UL synchronisation is restored. |

| | |
|---|---|
| NOTE 1: | SystemInformationBlockType31 (SystemInformationBlockType31-NB in NB-IoT) may be |
| | broadcast on a different narrowband or different NB-IoT carrier than the one configured |
| | to the UE. |
| NOTE 2: | The exact time when UL synchronisation is restored (after SystemInformationBlockType31 or |
| | SystemInformationBlockType31-NB in NB-IoT is acquired) is left to UE implementation, which |
| | can be from the subframe indicated by epochTime and optionally before the subframe indicated by |
| | epochTime. |

### Discontinuous Coverage

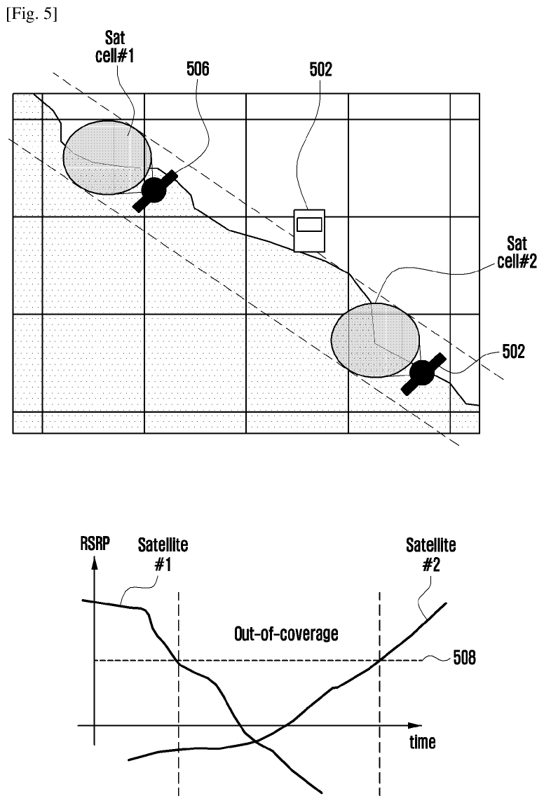

Discontinuous coverage is the scenario in which a LEO or MEO satellite network is not able to provide continuous coverage due to not having enough satellites to cover the whole earth. As the coverage moves, this means that coverage will be on and off. This is illustrated in FIG. 5 where the reference signal received power (RSRP) of each satellite 504 506 goes below a required threshold 508 thus not being able provide coverage to the UE 502. As an example, if there is only a single LEO satellite, the UE may see coverage as seldom as once every 24 hours for several minutes depending on the satellite coverage characteristics.

To allow for power saving when there is no coverage, the UE is allowed to power down and not perform any Access Stratum functionality, such as measuring and trying to detect cells. For the UE to be able to know when there is coverage or not, the network signals long-term ephemeris parameters that allow the UE to predict future satellite passes up to several days in the future. This is signaled in a new System information block (SIB) SIB32. In addition to ephemeris parameters, the network also signals coverage parameters that tells the UE how large the coverage is to better be able to estimate whether the satellite will provide coverage or not.

In idle mode many of the operations are based on UE implementation using the information elements provided by a new SIB-SIB32. In idle mode specifications the following is specified for the operation:

------------------------------ 36.304 V17.4.0 ------------------------------

If SystemInformationBlockType32 has been received and if the UE has determined that it is out of
coverage using available satellite assistance information (e.g. ephemeris parameters and coverage
parameters in current or previously received SystemInformationBlockType32,
SystemInformationBlockType31, t-Service in SystemInformationBlockType3 or other parameters), the AS
configuration (e.g. priorities provided by dedicated signalling and logged measurements) is kept, but
the UE need not perform any idle mode tasks related to NTN. It is up to UE implementation to handle
running timers. The detection of out of coverage using satellite assistance information is up to UE
implementation and once in NTN coverage the UE shall perform all idle mode tasks related to NTN.

------------------------------ 36.304 V17.4.0 ------------------------------

SIB32
To enable discontinuous coverage, the discontinuous coverage NTN provides uses a
new SIB called SystemInformationBlockType32.

------------------ 36.331 V17.4.0 ------------------

| | |
|---|---|
| - | SystemInformationBlockType32 |

The IE SystemInformationBlockType32 contains satellite assistance information for prediction of discontinuous
coverage. SystemInformationBlockType32 is only signalled in a NTN cell.

SystemInformationBlockType32 information element

| | |
|---|---|
| -- | ASN1START |

SystemInformationBlockType32-r17 ::= SEQUENCE {

| | | | |
|---|---|---|---|
| satelliteInfoList-r17 | SatelliteInfoList-r17 | OPTIONAL, | -- Need OR |

| | | |
|---|---|---|
| lateNonCriticalExtension | OCTET STRING | OPTIONAL, |

...

}

| SatelliteInfoList-r17 ::= | | SEQUENCE (SIZE (1..maxSat-r17)) OF SatelliteInfo-r17 | | |
|---|---|---|---|---|
| SatelliteInfo-r17 ::= | | SEQUENCE { | | |
| satelliteId-r17 | | INTEGER (0..255), | | |
| serviceInfo-r17 | | SEQUENCE { | | |
| | tle-EphemerisParameters-r17 | TLE-EphemerisParameters-r17 | OPTIONAL, | -- Need OR |
| | t-ServiceStart-r17 | TimeOffsetUTC-r17 | OPTIONAL | -- Need OR |

},

| | |
|---|---|
| footprintInfo-r17 | SEQUENCE { |

| referencePoint-r17 | SEQUENCE { | | |
|---|---|---|---|
| longitude-r17 | INTEGER (−131072..131071), | | |
| latitude-r17 | INTEGER (−131072..131071) | | |
| } OPTIONAL, -- Need OR | | | |
| elevationAngles-r17 | SEQUENCE { | | |
| elevationAngleRight-r17 | INTEGER (−14..14), | | |
| elevationAngleLeft-r17 | INTEGER (−14..14) | OPTIONAL | -- Need OP |
| } OPTIONAL, -- Need OR | | | |
| radius-r17 | INTEGER (1..256) | OPTIONAL | -- Need OR |

}

}

| | |
|---|---|
| -- | ASN1STOP |

SystemInformationBlockType32 field descriptions

elevationAngleLeft, elevationAngleRight
Leftmost and rightmost (with reference to the satellite direction) elevation angle. Unit in degree.
Step of 5 degree. Actual value = field value * 5.
If the field elevationAngleLeft is absent, the leftmost elevation angle is equal to the value of field elevationAngleRight.
footprintInfo
Satellite footprint.
E-UTRAN may configure elevationAngles and/or radius for earth moving cell.
E-UTRAN may configure referencePoint and radius for quasi-earth fixed cell.
latitude
Latitude of the reference point. Unit in degree.
Step of 360 / 262144 degree. Actual value = field value * (360 / 262144).
longitude
Longitude of the reference point. Unit in degree.
Step of 360 / 262144 degree. Actual value = field value * (360 / 262144).
radius
Distance between the reference point and the edge of the satellite or beam coverage. Unit in km.
Step of 10 km. Actual value = field value * 10.
serviceInfo
Information on when the satellite will provide coverage.
E-UTRAN always configures tle-EphemerisParameters for a satellite with earth moving cell(s) and always configures
t-ServiceStart for a quasi-earth fixed cell.
tle-EphemerisParameters
Mean values of the satellite orbital parameters based on the TLE set format for estimating in-coverage and out-of-
coverage periods for a satellite with earth moving cell(s), see TS 36.304 [4].
t-ServiceStart
Time information on when the incoming satellite is going to start serving the area for quasi-earth fixed cell.

------------------ 36.331 V17.4.0 ------------------

SIB32 contains the following information elements:
SatelliteId—This is used to tie an ephemeris field to an ID, such that if multiple satellites are provided and the list is updated, the UE may replace or create a new entry
TLE ephemeris parameters—this provides the TLE (Two Line Element) parameters for a satellite orbit and is used for earth-moving cells
T-ServiceStart—this provides the time when the area will served for quasi-earth fixed cells
footprintInfo—provides info on the size and geometry of the satellite coverage
referencePoint and radius—provides the reference point as well as radius of the satellite coverage area
elevationAngles—this is used in earth moving cell to define the coverage area

### Location Usage in Non-Terrestrial Networks

Early in the 3GPP studies on NTN it was realized that the location can be used to a great effect in a NTN. There are two reasons for this.
One is that the cells in a NTN tend to be much larger than in a terrestrial network (TN), where a NTN cell might be anywhere from the size of 10 km up to 250 km radius compared to a TN network that can typically be anywhere from several 100 m radius up to 10 km radius. This means that even a UE location with very large accuracy, could give sufficient information on for instance which cell a UE should be connected to.
Second reason is because of the large cells generated by the satellite antennas, the satellite antenna gain will be rather uniform over a very large distance on the ground. This means that if the satellite is stationary and the UE moves, even if the UE moves several kilometers in any direction, as long as it is in line-of-sight, the path gain induced by path loss and satellite antenna gain will not noticeably change. This is different from a terrestrial network where a similar move would cause a very large change in the path gain with a base station.

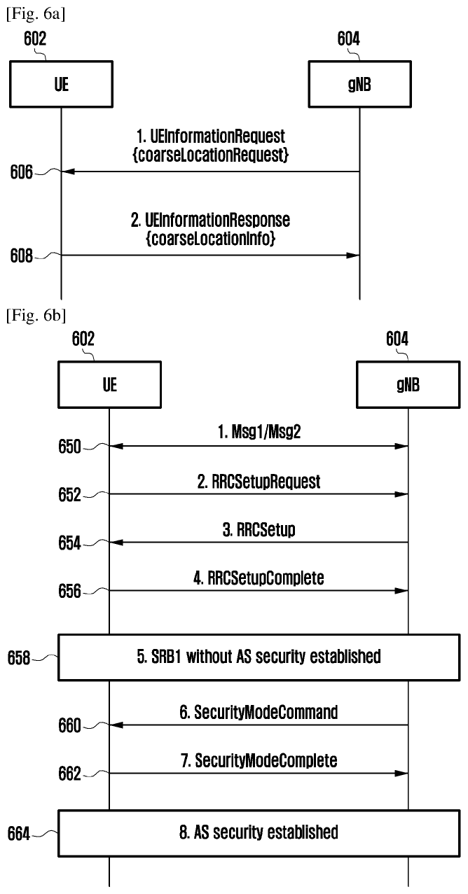

Due to this, in NTN there are several procedures that involve the location of the UE, which includes:
UE sending the coarse location over Radio Resource Control (RRC) when requested to by the gNB. This is useful in order for the gNB to decide which (virtual) cell and tracking area a UE should be reported to be associated with to the core network. This can be seen in FIG. 6a which illustrates sending coarse location in a UEInformationResponse 608 from a UE 602 to a gNB 604 when requested to through the UEInformtionRequest 606 sent from the gNB 604 to the UE 602.
Measurement reporting events based on the UE location.
Reporting of the UE location to adjust SSB Measurement Timing Configuration (SMTC)

### Access Stratum (AS) Security Procedures

In existing systems, when an RRC connection is being established via RRC setup procedures, the procedures will first establish a radio bearer that can be used for further configurations. This first radio bearer is SRB1 (Signalling Radio Bearer 1). Establishing SRB1 allows for continued configurations of the UE and the establishment of AS security. Configurations that can for instance be configured without AS security are measurement reports, MAC and PHY configurations etc.

AS security is established via the Initial AS security activation procedure between a UE 602 and a gNB 604, as illustrated in FIG. 6b. The initial AS security activation procedure follows the RRC setup procedure illustrated by messages 650, 652, 654, and 656 that results in an SRB1 without AS security being established at 658. The AS security is established 664 through the messages SecurityModeCommand 660 and SecurityModeComplete 662. The SecurityModeCommand 660 configures the specific security algorithms to be used and the SecurityModeComplete 662 acknowledges the successful establishment. When a UE receives the SecurityMode Command 660, the UE verifies the integrity protection of the message using derived keys, and if the integrity protection passes, then new keys are generated using the signaled ciphering algorithm. These keys are maintained for the SRB after the completion of the Initial AS security activation.

AS security supports both ciphering, which provides signaling data confidentiality, and integrity protection, which provides user or data integrity. AS security is supported for both signaling via SRBs or user data via DRBs (Data Radio Bearers). The keys used for ciphering and integrity protection are different for SRBs and DRBs, where SRBs (SRB1, SRB2, SRB3 and SRB4) share keys (K_{RRCint} and K_{RRCenc}) and DRBs have another set of keys (K_{UPint} and K_{UPenc}).

The keys may be updated, but this can only be done by using RRC Reconfiguration with sync, which causes the UE to perform random access before replying with the RRCReconfigurationComplete message.

### System Information

SIB19 is the system information block for NTN. SIB19 is key for a UE to connect to an NTN cell. This is as the SIB19 contains the ephemeris and common Timing Advance (TA). Ephemeris is used for the UE to calculate the satellite position which along with common TA is used to calculate the delay to the satellite, needed to synchronize.

In an ATG network, the situation is different compared to a normal NTN. In an ATG network, the base station is on the ground while the UE is far up in the air. Thus the base station will be stationary while UE moves very quickly. In LS R2-2302016/R4-2303684, RAN4 asks whether the SIB19 can be reduced for an ATG

RAN4 agreed ATG UE needs to perform time and/or frequency compensation. ATG BS is expected to provide
location information to assist UE-based time and/or frequency pre-compensation. The signaling of BS location
could use the IE EphemerisInfo in TS38.331 (as defined for NTN SIB19). Other solutions to provide ATG BS
location information are also not precluded in RAN4.
From RAN4 perspective, with the assumption of reusing SIB19 content for ATG, BS shall broadcast
EphemerisInfo to ensure ATG BS location can be received for the UEs which rely on SIB EphemerisInfo to do the
frequency/time pre-compensation. Note that ATG network will operate on the TN bands and the example bands
discussed in RAN4 are including n1, n77 and n79.
RAN4 would like to respectively request RAN2 to check whether SIB19 could be applied for ATG and if not,
whether an alternative could be applied to provide the ATG BS location to ATG UE from RAN2 perspective.

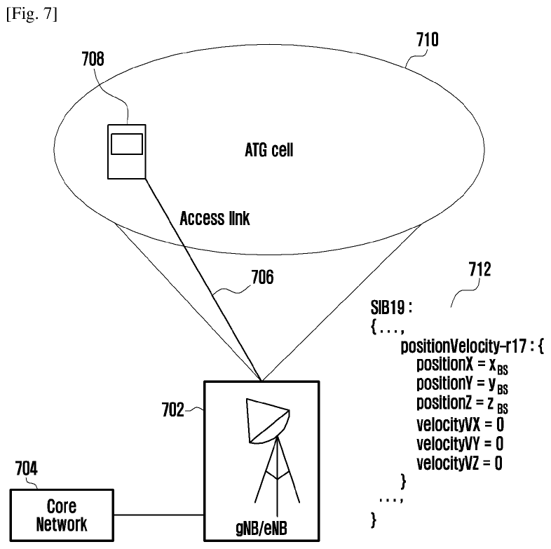

It would be advantageous to reuse the procedures developed for NTN in ATG. In NTN, the UE self-synchronize to account for frequency and timing by using the position of the UE (via performing GNSS measurements) and the position of the satellite (via acquiring the ephemeris). In an ATG network, the network could broadcast only one position in SIB19 using position Velocity-r17 with the velocity-components set to 0, as seen in FIG. 7, where the gNB/eNB 702 that is providing ATG cell 710 sends the SIB19 712 to the UE 708 via the access link 706. There are however aspects that are overly complicated if used in ATG networks.

Furthermore, there are other procedures as well as NTN-related capabilities that may need to be adjusted or changed when connecting to an ATG network.

In [R4-2300081], Discussion on general aspects for ATG UE RF, RAN4 #106, Qualcomm, March 2023], the following is stated regarding ATG SIB19:

In addition, it might have RAN2 specification impact on the reception procedure of SIB19 for ATG UE since ATG
UE might not need to maintain T430.

However, the above does not explain how a UE does not maintain the T430, since an NTN UE is currently required to obtain the SIB19 and start the T430. This disclosure addresses this problem and other shortcomings with respect to NTN procedures for ATG networks.

The following description of examples of the present disclosure, with reference to the accompanying drawings, is provided to assist in a comprehensive understanding of certain examples of the present disclosure. The description includes various specific details to assist in that understanding but these are to be regarded as merely exemplary. Accordingly, those of ordinary skill in the art will recognize that various changes and modifications of the examples described herein can be made without departing from the scope of the invention or disclosure.

The same or similar components may be designated by the same or similar reference numerals, although they may be illustrated in different drawings.

Detailed descriptions of techniques, structures, constructions, functions or processes known in the art may be omitted for clarity and conciseness, and to avoid obscuring the subject matter of the present disclosure.

The terms and words used herein are not limited to the bibliographical or standard meanings, but are merely used to enable a clear and consistent understanding of the disclosure.

Throughout the description of this specification, the words “comprise”, “include” and “contain” and variations of the words, for example “comprising” and “comprises”, means “including but not limited to”, and is not intended to (and does not) exclude other features, elements, components, integers, steps, processes, operations, functions, characteristics, properties and/or groups thereof.

Throughout the description of this specification, the singular form, for example “a”, “an” and “the”, encompasses the plural unless the context otherwise requires. For example, reference to “an object” includes reference to one or more of such objects.

Throughout the description, the expression “at least one of A, B and/or C” (or the like) and the expression “one or more of A, B and/or C” (or the like) should be seen to separately include all possible combinations, for example: A, B, C, A and B, A and C, A and B and C.

Throughout the description of this specification, language in the general form of “X for Y” (where Y is some action, process, operation, function, activity or step and X is some means for carrying out that action, process, operation, function, activity or step) encompasses means X adapted, configured or arranged specifically, but not necessarily exclusively, to do Y.

Features, elements, components, integers, steps, processes, operations, functions, characteristics, properties and/or groups thereof described or disclosed in conjunction with a particular aspect, embodiment or example are to be understood to be applicable to any other aspect, embodiment or example described herein unless incompatible therewith.

The following examples are applicable to, and use terminology associated with, 3GPP 4G (e.g., LTE) and/or 5G (e.g., NR). However, the skilled person will appreciate that the techniques disclosed herein are not limited to these examples or to 3GPP 4G (e.g., LTE) and/or 5G (e.g., NR), and may be applied in any suitable system or standard, for example one or more existing and/or future generation wireless communication systems or standards (e.g., B5G, 5G-Advanced, 6G etc.). The skilled person will appreciate that the techniques disclosed herein may be applied in any existing or future releases of 3GPP 4G (e.g., LTE) and/or 5G (e.g., NR) and/or 5G Advanced and/or 6G, and/or (3GPP Release 17, 18, 19, 20, etc.) or any other relevant standard. For example, the functionality of the various network entities and other features disclosed herein may be applied to corresponding or equivalent entities or features in other communication systems or standards. Corresponding or equivalent entities or features may be regarded as entities or features that perform the same or similar role, function, operation or purpose within the network.

Furthermore, the following also applies to the present disclosure:
The terms functionality/use-case/configuration/scenario/site may be used interchangeably.
The terms model and model functionality may be used interchangeably.
This disclosure also apply to non-3GPP entities.
The concepts, proposals, solutions, methods, embodiments, figures, and/or examples, presented in this disclosure, would apply to various type of communication systems, such as 4G, 4G-Advanced, 5G, 5G-Advanced, and 6G.

A particular network entity may be implemented as a network element on dedicated hardware, as a software instance running on a dedicated hardware, and/or as a virtualised function instantiated on an appropriate platform, e.g. on a cloud infrastructure.

The skilled person will appreciate that the present disclosure is not limited to the specific examples disclosed herein. For example:
The techniques disclosed herein are not limited to 3GPP 4G or 5G or 5G-Advanced and also apply to B5G and 6G systems.
One or more entities in the examples disclosed herein may be replaced with one or more alternative entities performing equivalent or corresponding functions, processes or operations.
One or more of the messages in the examples disclosed herein may be replaced with one or more alternative messages, signals or other type of information carriers that communicate equivalent or corresponding information.
One or more further elements, entities and/or messages may be added to the examples disclosed herein.
One or more non-essential elements, entities and/or messages may be omitted in certain examples.
The functions, processes or operations of a particular entity in one example may be divided between two or more separate entities in an alternative example.
The functions, processes or operations of two or more separate entities in one example may be performed by a single entity in an alternative example.
Information carried by a particular message in one example may be carried by two or more separate messages in an alternative example.
Information carried by two or more separate messages in one example may be carried by a single message in an alternative example.
The order in which operations are performed may be modified, if possible, in alternative examples.
The transmission of information between network entities is not limited to the specific form, type and/or order of messages described in relation to the examples disclosed herein.

Certain examples of the present disclosure may be provided in the form of an apparatus/device/network entity configured to perform one or more defined network functions and/or a method therefor. Such an apparatus/device/network entity may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). Certain examples of the present disclosure may be provided in the form of a system (e.g., a network) comprising one or more such apparatuses/devices/network entities, and/or a method therefor.

### Non-Terrestrial Network Procedure Adaptations

This disclosure provides methods for adapting for ATG networks contents of SIB19 and NTN operation, which is normally used for NTN where the base station components are in the satellite and subsequently moving (gNB is on the ground in NTN, but the UE synchronizes with a satellite). In a ATG network, the UE would need to synchronize with a network on the ground that is stationary.

In this disclosure the notion of ATG network and network may be used interchangeably. In other words a “network” should not be taken to mean a non-ATG network.

In terms of base stations, the notion of gNB may be interchanged with a BS/eNB/NG-RAN/NG-eNB or similar. This also means that the methods in this disclosure may not only applied to 5G NR, but also 4G E-UTRAN including IoT technologies such as eMTC or NB-IoT. It can thus be applicable to IoT NTN, which is based on 4G E-UTRAN as well.

In terms on the wireless device, ATG UE and UE may refer to the same type of wireless device. In other words a “UE” should not be taken to mean a “non-ATG UE”.

### SIB19 and Uplink Sync Validity Operation

In one example, the UE will not perform the uplink synchronization operation as in NTN. The benefits of this is that the SIB19 does not need to be continuously acquired, for example it can only be acquired once and synchronisation performed based on the single received instance of SIB19. This makes it so that the synchronization implementations for ATG can be made more simple.

This can be done in the following ways:
Network Signaling: Applying uplink sync validity duration with infinity value (example of this seen in Example 1 below)
   This can be implemented by the network by signaling an infinity value, or
   In an ATG network, the UE can be configured to apply an infinity value, thus the value signaled or not signaled will be ignored, or
   The uplink sync validity with an infinity value is applied if the uplink sync validity duration is not signaled for serving cell
Network Signaling: Signalling a flag that SIB19 does not need to be reacquired unless signaled, where this signalling may for example be in SIB19 itself.
   This can be a flag ul-SyncNotRequired.
UE Behaviour: A UE connecting to an ATG cell or an ATG network can automatically assume that re-acquiring SIB19 is not necessary.
   The UE may be aware that it is an ATG cell or network based on for instance a flag in SystemInformation such as SIB1. It may also be implicit based on the implementation or the band utilized.
   The UE may not start T430 in a ATG cell, but only acquires the SIB19 it when connecting to an ATG cell. This example can be seen in Example 2 below.
   This may simplify the procedures.
   The ATG UE will synchronize once when connecting, and then since the timer is not expired, the ATG UE will never be considered to be un-synchronized. When a ATG UE performs a handover, the UE may not start the T430 timer.
   The ATG UE will always be considered synchronized as long as the ATG UE reads the SIB19 before connecting to an NTN.
   ATG UE does not need to re-read the SIB19 when resuming or re-establishing.

In one example, the NTN ephemeris is not signaled in the SIB19. Instead an ATG reference location for the purpose of synchronization is signaled. This reference location is used as a synchronization point and may be read continuously.

The above examples may also be applicable to synchronization operation in IoT NTN, whereby the SIB31 is used and the timer is T317.

In summary, in the above examples, the SIB19 is broadcast by the gNB/eNB and received by the UE. The content of SIB19 may be adapted and/or the behaviour of the UE may be adapted. Adaptation of UE behaviour compared to NTN may be implemented by network signalling and/or predefined changes to UE operation in relation to ATG networks.

### Fields Signaled in ATG SIB19

In an ATG network there are several information elements that may not be needed and thus may not need to be sent or received, or not be present for an ATG NTN:
epochTime—this field can be ignored
ntn-UlSyncValidityDuration—this may not be present in a ATG NTN as is explained above.
ta-Info—since the synchronization point would be on the ground, this field may not be present or ignored in a ATG network.

Thus in an example, an ATG gNB is configured to not include one or more of the above information elements. Alternative, ones or more of these fields/information elements may still be included in SIB19 broadcast by the gNB and/or or set to an arbitrary value and thus received by the UE but subsequently ignored by the UE when performing and/or updating synchronisation or other SIB-based operations for example.

### Location-Based Operations—Including Height in Location Configurations

In NTN, the UEs are considered to be on the ground. However, in an ATG network the UEs will be in the sky while the BS is on the ground. A reference location which is compared to the UE location is often used in many procedures such as measurement reporting, but the reference location is defined as a point on the surface of the earth.

| | |
|---|---|
| | -------------------------- 38.331 V17.4.0 -------------------------- |
| - | ReferenceLocation |

The IE ReferenceLocation contains location information used as a reference location. The value of the field is
same as Ellipsoid-Point defined in TS37.355 [49]. The first/leftmost bit of the first octet contains the most
significant bit.

ReferenceLocation information element

| | |
|---|---|
| -- | ASN1START |
| -- | TAG-REFERENCELOCATION-START |

ReferenceLocation-r17 ::= OCTET STRING

| | |
|---|---|
| -- | TAG-REFERENCELOCATION-STOP |
| -- | ASN1STOP |
| | -------------------------- 38.331 V17.4.0 -------------------------- |
| | -------------------------- 37.355 V17.4.0 -------------------------- |
| - | Ellipsoid-Point |

The IE Ellipsoid-Point is used to describe a geographic shape as defined in TS 23.032 [15].

| | |
|---|---|
| -- | ASN1START |

Ellipsoid-Point ::= SEQUENCE {

| latitudeSign | ENUMERATED {north, south}, | |
|---|---|---|
| degreesLatitude | INTEGER (0..8388607), | -- 23 bit field |
| degreesLongitude | INTEGER (−8388608..8388607) | -- 24 bit field |

}

| | |
|---|---|
| -- | ASN1STOP |
| | -------------------------- 37.355 V17.4.0 -------------------------- |

In one example, locations are defined with heights to define reference locations in the sky as in implementation Example 4 below. These heights may be different for each BS and thus different heights are indicated in the SIB transmitted by each BS.

In another example, a default height is configured for all reference locations. This can for instance be configured in SIB19. A typical value would for instance be 30000 ft or 10000 meters-optimized for the aviation sector.

With the added height above, all related reference locations may be interpreted with the configured height. This may lead to improved determination of UE location compared to cell location

### Location-Based Operations—3D Distances

Some procedures use the 2D distance (measurement reporting event CondEventD1 and RRC idle/inactive distance-based cell reselection method using distanceThresh and referenceLocation) (3GPP 38.331 V17.4.0, 3GPP TS 38.304 V17.4.0) to evaluate whether certain actions shall be performed or not. In order for the procedures to function in an ATG network, in one example, the 3D distances are used. This can be configured in the following manners:
A flag indicating that the 3D distances shall be used in the evaluation, where this may for example be in NTN SIB, SIB19
If the referenceLocation with height is signaled, the ATG UE assumes that 3D

distances shall be used
The ATG UE always uses the 3D distance

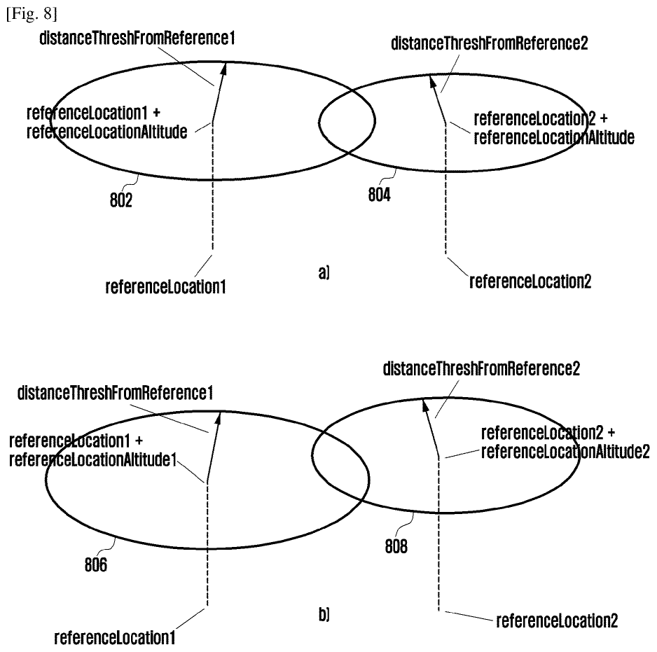

For a conditional handover event, the reference locations can have the same altitude or be separately signaled. This same altitude can make sense in some networks where the location of the cell is expect to be the same for all cells. These two options can be seen in FIG. 8. In a) the altitudes for the ATG cells 802 and 804 are the same and in b) the altitudes for the ATG cells 806 and 808 are separate/different i.e. referenceLocationAltitude1 and referenceLocationAltitude2.

### Reporting of Position in ATG Network

In one example, when the ATG UE sends a measurement report, the ATG UE includes the height in the position element. This is important as the height is less obvious in a ATG network compared to an NTN and the location can be useful for the network to know. This can be used by the network to determine which cell an ATG UE should be connected to, i.e. whether mobility is required, or to update the core network on where the UE is located etc.

Along with the position and altitude, the ATG UE may also be configured to report items such as uncertainty in latitude, longitude as well as altitude. Furthermore the UE can be configured to report vertical and/or latitude/longitude velocity. In another example, these parameters maybe reported at different granularity (e.g. coarse or fine or other) or accuracy levels (e.g. low, medium, or high or other).

An ATG UE can for instance autonomously be including the height in the response to a request when the UE is in an ATG network. This means that when the UE receives a coarseLocationRequest in a UEInformationRequest, the UE responds not only with the coarseLocationInfo but also the height, such as coarseAltitude.

As an NTN UE is configured to report the coarse location information, where the coarse location is coarse in longitude and latitude, the UE if reporting the coarse location with altitude should also introduce similar. This could for instance be a coarse-ness of several hundred meters, to make it more challenging to exactly pinpoint the location of an ATG UE.

In another related example, the UE may be configured to report the location information at higher granularity (or finer granularity or detailed location information). The reporting of UE position may be performed using the procedure illustrated in FIG. 6a albeit adapted as above.

In any of the above examples, figures, and description, the network may require user consent on obtaining any of the information reported from the ATG UE. This could be achieved as part of the ATG UE subscription information, configured in the network (e.g. configured in RAN or CN), e.g. via network operators or OAM, or based on regional policies, or based on any assistance information from internal and/or external network entity or function.

In another example, the ATG UE may provide the user consent to the network.

The enhanced coarse location reporting can be done using UEInformationRequest/UEInformationResponse or RRC measurement reporting.

### ATG Discontinuous Coverage

Techniques used for NTN discontinuous coverage can be used for a ATG UE to know when there will be coverage available for an ATG UE.

In one example, the ATG network broadcasts elements related to discontinuous coverage to provide coverage related information to know when coverage is available. Due to the discontinuous coverage information normally being applicable to satellites, which involve satellite orbits (ephemeris elements), there can be a number of adaptations:
Broadcast fixed locations instead of ephemeris elements
Including heights in location-based configurations
This means that the coverage can be described using height parameters. For instance if coverage is only provided up to 5000 m height, this will be signaled and taken into account by an ATG UE when measuring and/or attempting to connect to an ATG UE

### Capabilities and Other Supported NTN Features

An ATG UE may be based on an NTN UE but simplified, i.e. that certain features that are needed for NTN are not needed for an ATG UE. (TS 38.306 V17.4.0)

In one example, one such feature that may not be supported for an ATG UE is service link propagation delay compensation. This feature is used by the gNB to adjust the measurement timing windows, using the feature serviceLinkPropDelayDiffReporting.

In another example, another feature that may not be supported for ATG UE is the parallelMeasurementGap. This features introduces two parallel measurement gaps used for tracking neighbour satellite cell measurements.

In another example, another feature that may not be supported for ATG UE is the parallelSMTC feature. i.e. an ATG UE does not need to implement parallel SMTC for its operations.

The ATG capabilities may be signaled separately or based on NTN, but with exceptions such as the ones above.

In another example, the ntn-ScenarioSupport is not included for ATG UE, but a separate ATG-scenario support is included, and this can bring some of the above conditions. For instance, if a UE signals support for nonTerrestrialNetwork and atg-Support but not ntn-ScenarioSupport, certain NTN features are not applicable to ATG UE.

Even though a UE may support both ATG and NTN scenarios, certain features are still employed in a ATG network by the gNB. This may reduce the amount of needed testing required when implementing a feature.

In an example, the UE may report its support for ATG operation as part of its UE capability to the network. In one example, the UE reports the new capability using a new IE (e.g. ATGCapability IE, or any other suitable naming).

In another embodiment, the UE ATG capability maybe included (or stored) in the UE context by the network.

### Secure ATG Network Location Reporting

The location of a base station is generally considered sensitive (i.e. secure) information and thus its reporting/provision a sensitive procedure. With respect to NTNs, a UE may require the location of the NTN node (i.e. the satellite or HAPS) in order to synchronize and therefore location information may be broadcast as part of system information. However, in NTNs, the satellite or the HAPS that provides the connectivity are normally far up in the sky and moving very quickly. Due to this fast movement and the need to synchronize it is considered acceptable to broadcast the location of the NTN node, i.e. a network node. In an ATG network, a UE may also require a location of a (ATG) base station to perform synchronisation with the associated gNB, and this may be done by the ATG gNB broadcasting its base station location using the NTN signaling. However, since the base station location is stationary and on the ground, such location information is more sensitive and therefore preferably it should not be exposed in broadcast information whilst still allowing synchronisation to be performed.

In this disclosure, base station location information is referring to the physical location of a base station from which signals for a UE are communicated (i.e. the physical transmission point), whereas ATG gNB is referring to the logical entity that performs the communications with the UE. Consequently, although the location of an ATG (or normal) gNB may be the same as that of its associated base station, this may not always be the case. In some cases (ATG) gNB location or synchronization point location may be referred to, which is referring to the physical location of the transmission point of signals from the (ATG) gNB i.e. the physical location of its associated base station location. Furthermore, reference to an ATG UE refers to a UE that has ATG communication capabilities, but reference to a merely UE does not exclude the UE from being capable of ATG communications.

One way of allowing for a base station to not reveal its location whilst still allowing for synchronization is to “spoof” the base station location by a small percentage or within a certain tolerance i.e. intentionally provide an imprecise location or a lower precision location. For example, if the base station is located at position x1, y1, z1, then an additional vector xS, yS, zS may added to form the location that is broadcast, where the additional vector is smaller than the position vector, having a size in region of 1 to 100 meters for instance, although it may take any suitable size smaller or larger than this. Alternatively, the network (i.e. ATG gNB) may broadcast a base station location with reduced accuracy or reduced granularity or increased coarseness. However, an issue is to strike a balance between synchronization and network anonymity and security. For example, a more imprecise broadcast location may hinder synchronisation but improve network anonymity and security, and vice versa.

In accordance with an example of the present disclosure, the network broadcasts a spoofed location (i.e. a purposively inaccurate/uncertain location), and then provides another more precise location (or higher accuracy or higher granularity or more detailed location) to the UE(s) that are authenticated and have established AS security. This can allow for an improved balance between synchronisation and security by allowing initial synchronisation to be performed based on broadcast information that does not reveal the precise location of the base station but allowing authenticated UEs to access the precise location so that they can achieve more accurate synchronisation and subsequently operate as if the precise location of the base station had been initially provided.

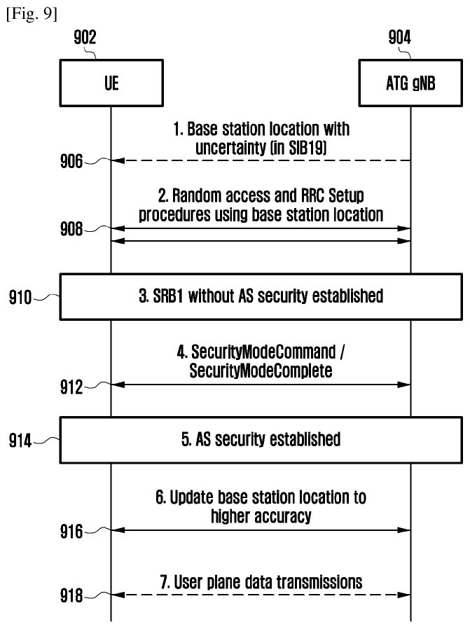

FIG. 9 provides an example RRC setup and AS security procedure that is based on broadcasting a spoofed base station location by the associated ATG gNB 904 and then updating an ATG UE 902 with higher accuracy location information once AS security has been established.

At 906, the ATG gNB broadcasts its location information (i.e. that of its associated base station) at a reduced accuracy in a system information and the ATG UE receives the system information. For example, an ATG UE in RRC idle or RRC inactive mode acquires the broadcast base station location (using system information, e.g. periodically and/or on-demand, using existing and/or newly defined SIBs.)

At 908, the ATG UE synchronizes with the ATG gNB using the reduced accuracy location information and performs RRC setup via random access to establish a SRB1 without AS security (see also 650-658 of FIG. 6b).

At 912, the ATG UE performs an AS security procedure to establish AS security with the ATG gNB at 914 (see also 660-664 of FIG. 6b).

After AS security has been established, at 916 the ATG UE receives a more precise location (or higher accuracy or higher granularity or more detailed location) of the base station, via dedicated signaling/messages (e.g. existing and/or newly defined RRC messages/signaling). Further communications (e.g. user plane data transmissions 918) or selected further communications with the ATG gNB can then be performed based on the more precise location.

In some examples, the procedure of FIG. 9 may include the network (e.g. ATG gNB) informing the ATG UE that a higher precision location or detailed location is available. The indication can be a flag such as 1/0 (‘1/0’=high accuracy location available/not available). For example, highAccuracyPosition IE={1, 0}, or any other suitable naming. The ATG UE may then may be sent, request or otherwise receive the higher precision location. The indication may be provided before or after AS security has been established.

In some examples, the network may provide different granularities of position accuracy to different types of ATG UE(s), e.g. based on UE(s) subscription, and/or other information on the network and/or the ATG UE, such as UE capability for example.

In some examples, the ATG UE is configured (e.g. by the network) to request the detailed location (or a higher accuracy location) of the base station upon establishment of AS security. This request may be configured as default or made in response to an indication (e.g. a flag) that higher precision location information is available. For instance, the ATG UE may check the flag, highAccuracyPosition IE={1, 0}, which may be broadcast (e.g. via system information periodically and/or on-demand, using existing and/or newly defined SIBs) and/or dedicated RRC signaling/messages (e.g. existing and/or newly defined) and make a request for the detailed location information accordingly.

In another example, the ATG UE may request information related to the availability of a precise base station location before, during and/or after AS security establishment. Such a request may be made by including a flag (or indication or request) in any of the existing and/or newly defined RRC messages/signalling. For example, RRCSetupRequest, RRCSetupComplete, RRCResumeRequest, RRCResumeComplete, RRCReestablishmentRequest, RRCReestablishmentComplete or RRCReconfigurationComplete, and/or any other suitable RRC messages.

In another example, the network may configure the ATG UE access to precise base station location, i.e. make the access to the information configurable. For example, based on the UE capability, subscription, and/or other information. As an example, the AMF may decide whether a specific ATG UE is allowed to access detailed base station location. The permission to access the precise location information may be sent to the ATG gNB, where by the ATG gNB delivers the precise location. For example, using existing and/or newly signaling/messages/IEs over NG interface. For example, using any of UE Context Management Procedures

If access is controlled by the AMF, the AMF upon verifying whether the ATG UE is allowed or not allowed access to the detailed (or higher accuracy) base station location, may decide to reject a UE request to the detailed base station location. Optionally, the AMF may provide a new cause value for the rejection, e.g. detailedgNBLocationNotAllowed/Supported and/or any other suitable naming. Access verification, may be based on subscription information obtained from the Unified Data Management (UDM), and/or based on other assistance information from the network, e.g. information obtained from the Network Data Analytics Function (NWDAF) and/or the ATG gNB.

In another example, the network may release the ATG UE if the ATG UE request for a higher accuracy (or different granularity) base station location information was rejected (or failed). For example, using UE Context Release Request (NG-RAN node initiated), or UE Context Release (AMF initiated) procedures/messages, RRC signaling/messages, and/or newly defined signaling and/or messages

In another example, the gNB may verify the ATG UE request for detailed (or higher accuracy or precise) base station location information and either accept or reject the request. For example, include a rejection or failure to share information cause value, such as detailedgNBLocationNotAllowed/Supported and/or any other suitable naming.

In another example, the UE may obtain (or request) a higher accuracy base station location from other network entities (and/or functions), such as from the Location Management Function (LMF), i.e. via the LTE Positioning Protocol (LPP).

In another example, the gNB provides a higher accuracy (or more detailed) location information of the base station based on an indication from the AMF (and/or any other network entity and/or network function).

As a variation on the approach of FIG. 9, the network may send the more precise location as long as the ATG UE is in connected mode. Thus AS security may not need to be established before sending the more precise location.

In another example, the higher precision information or information for deriving it may be broadcast but in an encrypted form, so that only ATG UEs that have been configured with the appropriate key(s) can access the higher precision information. For instance, both the lower precision and higher precision information (or information required to derive the higher precision information e.g. a correction vector or function) may be included in broadcast system information but with the higher precision information encrypted so that access to it can be controlled by the network's distribution of encryption keys. Encryption keys may be configured and distributed by the network and may have a time-based or location-based validity for example. Encryption keys may be provided by the ATG gNB with which the higher-precision location information is associated or by another gNB or ATG gNB. In such an this approach, depending on the distribution of the key(s) access to the higher precision information may be available before or after AS security has been established.

The actual data of the more precise location information may be provided in different manners. For example, the full (at or least higher) precision location information may be sent in its entirety, or a correction to the lower precision location information may be sent, where the correction may take a number of different forms, such as a function or quantitative adjustments.

With respect to providing the higher precision location information in its entirety, it can for instance have a larger granularity compared to the coarse location, or a more precise value that more accurately represents the true base station location.

With respect to providing a correction to the lower precision location information, a correction vector may be provided that includes x, y, z components. If the location is only randomized in x and y, the correction vector may only contain an x and y component. Such a correction vector may be applied via addition (e.g. P_{synch conn mode}=P_{broadcasted}+P_{correction}) or subtraction (e.g. P_{Synch conn mode}=P_{broadcasted}−P_{correction})

In terms of how such a higher precision location or correction may be applied by the ATG UE, the ATG UE may apply it to only the base station position which the ATG UE is in connected mode via or when the ATG UE is in connected mode with a ATG gNB. The correction (and not the precise location) may also be applied to multiple base station locations over time. For instance when the ATG UE connects and receives the correction, this can be applied to multiple base stations as the aircraft moves through an ATG network. There can for instance be a time associated with the correction, which can be configured with the correction, or can be hardcoded. For instance the correction can be applied for 24 hours to one or more base stations. Outside of such a time the coarse base station location can still be used for limited connections. Alternatively, the correction may be updated more frequently, either by new corrections being received or the correction being a function of time or other parameters for instance.

In another example, one or more base station location corrections can be applied to neighbouring cell base station locations, which are used for measurement purposes.

As can be appreciated from the foregoing examples, the provision of a correction to a lower precision location as opposed to merely providing a higher precision location can lead to a number of alternatives and expanded use cases.

With respect to signalling, the correction or precise location can be configured by an ATG gNB via the following example RRC messages
RRCReconfiguration message—See Example #5
This can contain an element representing the correction. In case of Carrier Aggregation or Dual Connectivity operation in ATG, the correction may be per cell or per per cell group.
A new RRC message dedicated to sending the correction/precise location

In accordance with examples where the ATG UE may request the correction from the network, such a request may be performed by including a flag in any RRC message. Suitable messages include-Complete messages such as RRCSetupComplete, RRCResumeComplete, RRCReestablishmentComplete or RRCReconfigurationComplete.

To assist with keeping the base station position secure, the broadcast position can change over time. For instance, every 24 hours, the broadcast position may be changed. This means that the correction vector also needs to be updated regularly and/or a higher precision location to be re-provided.

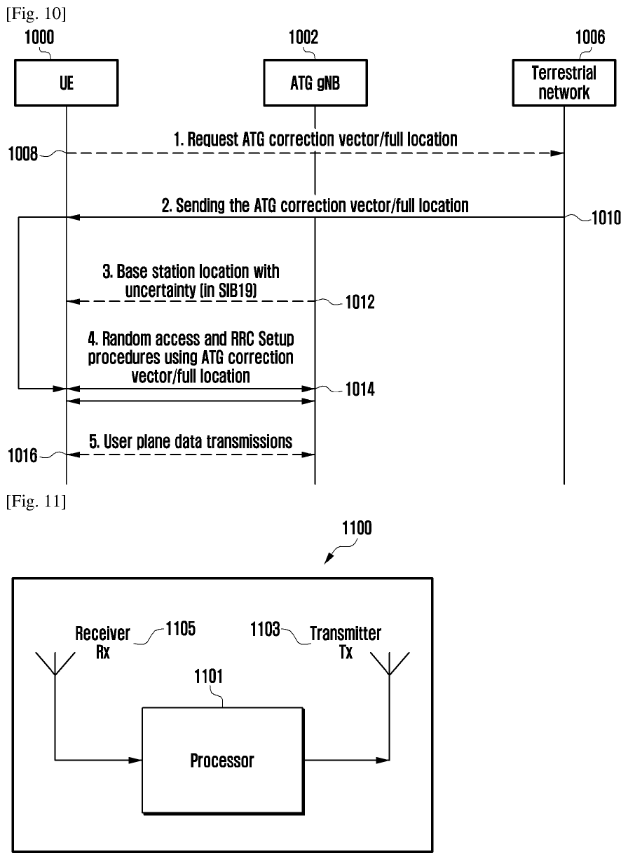

FIG. 10 illustrates an alternative approach to the provision of higher precision location information either via correction or the provision of full location information. In particular, information on a higher precision location is provided to a UE before it attempts to synchronise with an ATG network. For example, the ATG UE may be configured with a correction vector (or full location information) using other alternatives such as OAM, or via the core network. This can for instance be configured via a terrestrial network before the ATG UE starts connecting to an ATG network. This correction vector may be applied to the broadcast location before synchronizing and performing random access. The request to receive the correction vector may be sent to a gNB or to the terrestrial core network. Sending the correction vector may also be initiated by the terrestrial network before the UE enters the ATG network.

As an example, such information may be provided prior to synchronisation with an ATG gNB. For instance, if the ATG UE is an aircraft, the correction vector can be received when the UE is connected to a terrestrial network before take-off. This would for instance allow for a much larger “spoofing” or coarse location, that could for instance be off by several 100 meters. In some instances, information on ATG gNBs/bases stations expected to be encountered by the UE may be known by the terrestrial network, and correction vectors/precise location provided on for multiple ATG gNBs.

Referring to FIG. 10, at 1008 the UE 1000 may request ATG correction vector/full location from a terrestrial network 1006 that it is connected to. The terrestrial network may then send at 1010 the ATG correction vector/full location to the UE. Subsequently, the RRC setup procedure with the ATG gNB 1002 illustrated by 1014 may be based on the full location received from the terrestrial network or the RRC setup procedure 1014 may be based on the low precision broadcast location information corrected with the correction vector received from the terrestrial network. User plane transmissions at 1016 may then be performed as normal with the ATG gNB.

Although primarily described with respect to ATG networks (i.e. ATG UEs and ATG gNBs), the approaches to base station location obfuscation set out above are also applicable to other types of networks such as NTN, where there may also be a need to keep the network nodes hidden to a certain degree in certain scenarios. For instance in NTN, a competitor could for instance acquire the broadcasted ephemeris to deduce how the satellite constellation is employed or how the satellite station keeping is performed. Such approaches may also be applied to terrestrial networks.

The adaptions to the procedures performed by the UE and gNB/eNB for ATG networks set out above and also the adaptations to the data sent and received by the UE and gNB/eNB for ATG networks set out above may be combined in any combination. Furthermore, new forms of information may be included in any appropriate form, such as information element, message, and/or system information block. Any examples of data that is not required for ATG network compared to NTN may be ignored by a UE and/or gNB/eNB, omitted from transmissions, or set to an arbitrary value.

The adaptions to the procedures performed by the UE and gNB/eNB for ATG networks set out above and also the adaptations to the data sent and received by the UE and gNB/eNB for ATG networks set out above may be implemented by the UE, the gNB, or a combination of these entities. Furthermore, existing procedures and signalling set out in the above-referenced standards may be used but with their informational content adapted as set out above.

### Example 3GPP Specification Modification

In view of the examples set out above, the following provides example additions/adaptations that may be introduced into the 3GPP specification, where the highlighted parts represent some of the additions/adaptations.

### Example 1

----------------------------- 38.331 V17.4.0 EXAMPLE -----------------------------

| | |
|---|---|
| 5.2.2.4.21 | Actions upon reception of SIB19 |

Upon receiving SIB19, the UE in RRC_CONNECTED shall:

1> For a UE in an ATG network:

2> start or restart T430 for serving cell with the timer value set to infinity for the serving cell;

| | |
|---|---|
| 1> | else: |

2> start or restart T430 for serving cell with the timer value set to ntn-UlSyncValidityDuration

for the serving cell from the subframe indicated by epochTime for the serving cell;

| NOTE: | For NTN, UE should attempt to re-acquire SIB19 before the end of the duration indicated by ntn- |
|---|---|
| | UlSyncValidityDuration and epochTime by UE implementation. |

----------------------------- 38.331 V17.4.0 EXAMPLE -----------------------------

### Example 2

----------------------------- 38.331 V17.4.0 EXAMPLE -----------------------------

| | |
|---|---|
| 5.2.2.4.21 | Actions upon reception of SIB19 |

Upon receiving SIB19, the UE in RRC_CONNECTED shall:

| | |
|---|---|
| 1> | if UE is not an ATG UE or not connecting to a ATG cell: |

| | |
|---|---|
| 2> | start or restart T430 for serving cell with the timer value set to ntn-UlSyncValidityDuration for the |

| | serving cell from the subframe indicated by epochTime for the serving cell; |
|---|---|
| NOTE: | UE should attempt to re-acquire SIB19 before the end of the duration indicated by ntn- |

UlSyncValidityDuration and epochTime by UE implementation.

| | |
|---|---|
| | <OMITTED> |
| 5.3.5.5.2 | Reconfiguration with sync |

The UE shall perform the following actions to execute a reconfiguration with sync.

| 1> | if the AS security is not activated, perform the actions upon going to RRC_IDLE as specified in 5.3.11 |
|---|---|
| | with the release cause ‘other’ upon which the procedure ends; |
| 1> | stop timer T430 if running; |
| 1> | if the UE is not an ATG UE or connecting to an ATG cell, start timer T430 with the timer value set to ntn- |

UlSyncValidityDuration from the subframe indicated by epochTime, according to the target cell NTN-
config;
----------------------------- 38.331 V17.4.0 EXAMPLE -----------------------------

### Example 3

| | |
|---|---|
| | ----------------------------- 38.331 V17.4.0 EXAMPLE ----------------------------- |
| - | NTN-Config |

The IE NTN-Config provides parameters needed for the UE to access NR via NTN access.

| | | NTN-Config information element |
|---|---|---|
| -- | ASN1START | |
| -- | TAG-NTN-CONFIG-START | |
| NTN-Config-r17 ::= | | SEQUENCE { |
| | epochTime-r17 | EpochTime-r17 |

OPTIONAL, -- Need R

| | |
|---|---|
| ntn-UlSyncValidityDuration-r17 | ENUMERATED{ s5, s10, s15, s20, s25, s30, s35, |

s40, s45, s50, s55, s60, s120, s180, s240, s900}

OPTIONAL, -- Cond SIB19

| | |
|---|---|
| cellSpecificKoffset-r17 | INTEGER (1..1023) |

OPTIONAL, -- Need R

| | |
|---|---|
| kmac-r17 | INTEGER (1..512) |

OPTIONAL, -- Need R

| | |
|---|---|
| ta-Info-r17 | TA-Info-r17 |

OPTIONAL, -- Need R

| | |
|---|---|
| ntn-PolarizationDL-r17 | ENUMERATED {rhcp, lhcp, linear) |

OPTIONAL, -- Need R

| | |
|---|---|
| ntn-PolarizationUL-r17 | ENUMERATED {rhcp, lhcp, linear) |

OPTIONAL, -- Need R

| | |
|---|---|
| ephemerisInfo-r17 | EphemerisInfo-r17 |

OPTIONAL, -- Need R

| | |
|---|---|
| ta-Report-r17 | ENUMERATED {enabled} |

OPTIONAL, -- Need R

...

}

| EpochTime-r17 ::= | | SEQUENCE { |
|---|---|---|
| | sfn-r17 | INTEGER (0..1023), |
| | subFrameNR-r17 | INTEGER (0..9) |

}

| TA-Info-r17 ::= | | SEQUENCE { |
|---|---|---|
| | ta-Common-r17 | INTEGER (0..66485757), |
| | ta-CommonDrift-r17 | INTEGER (−257303..257303) |

OPTIONAL, --Need R

| | |
|---|---|
| ta-CommonDriftVariant-r17 | INTEGER (0..28949) |

OPTIONAL -- Need R
}

| | |
|---|---|
| -- | TAG-NTN-CONFIG-STOP |
| -- | ASN1STOP |

NTN-Config field descriptions

EphemerisInfo
This field provides satellite ephemeris either in format of position and velocity state vector or in format of orbital parameters.
This field is excluded when determining changes in system information, i.e. changes to ephemerisInfo should neither result in
system information change notifications nor in a modification of valueTag in SIB1.
epochTime
Indicate the epoch time for the NTN assistance information. When explicitly provided through SIB, or through dedicated
signaling, the EpochTime is the starting time of a DL sub-frame, indicated by a SFN and a sub-frame number signaled
together with the assistance information. For serving cell, the field sfn indicates the current SFN or the next upcoming SFN
after the frame where the message indicating the epochTime is received. For neighbour cell, the sfn indicates the SFN
nearest to the frame where the message indicating the epochTime is received. The reference point for epoch time of the
serving or neighbour NTN payload ephemeris and Common TA parameters is the uplink time synchronization reference
point. If this field is absent, the epoch time is the end of SI window where this SIB19 is scheduled. This field is mandatory
present when ntn-Config is provided in dedicated configuration. If this field is absent in ntn-Config provided via NTN-
NeighCellConfig the UE uses epoch time of the serving cell, otherwise the field is based on the timing of the serving cell, i.e.
the SFN and sub-frame number indicated in this field refers to the SFN and sub-frame of the serving cell. In case of handover
or conditional handover, this field is based on the timing of the target cell, i.e. the SFN and sub-frame number indicated in this
field refers to the SFN and sub-frame of the target cell. For the target cell the UE considers epoch time, indicated by the SFN
and sub-frame number in this field, to be the frame nearest to the frame in which the message indicating the epoch time is
received. This field is excluded when determining changes in system information, i.e. changes to epochTime should neither
result in system information change notifications nor in a modification of valueTag in SIB1.
This field is ignored if ntn-UlSyncValidityDuration value infinity is signalled.
cellSpecificKoffset
Scheduling offset used for the timing relationships that are modified for NTN (see TS 38.213 [13]). The unit of the field
K_offset is number of slots for a given subcarrier spacing of 15 kHz. If the field is absent UE assumes value 0.
kmac
Scheduling offset provided by network if downlink and uplink frame timing are not aligned at gNB. It is needed for UE action
and assumption on downlink configuration indicated by a MAC CE command in PDSCH (see TS 38.213 [13]). If the field is
absent UE assumes value 0.
For the reference subcarrier spacing value for the unit of K_mac in FR1, a value of 15 kHz is used. The unit of K_mac
is number of slots for a given subcarrier spacing.
ntn-PolarizationDL
If present, this parameter indicates polarization information for downlink transmission on service link: including Right hand,
Left hand circular polarizations (RHCP, LHCP) and Linear polarization.
ntn-PolarizationUL
If present, this parameter indicates Polarization information for uplink service link.
If not present and ntn-PolarizationDL is present, UE assumes the same polarization for UL and DL.
ntn-UlSyncValidityDuration
A validity duration configured by the network for assistance information (i.e. Serving and/or neighbour satellite ephemeris and
Common TA parameters) which indicates the maximum time duration (from epochTime) during which the UE can apply
assistance information without having acquired new assistance information.
The unit of ntn-UlSyncValidityDuration is second. Value s5 corresponds to 5 s, value s10 indicate 10 s and so on. This
parameter applies to both connected and idle mode UEs. If infinity value is signalled, the UE does not need to re-acquire the
SIB19 according to the timer. If this field is absent in ntn-Config provided via NTN-NeighCellConfig, the UE uses validity
duration from the serving cell assistance information. This field is excluded when determining changes in system information,
i.e. changes of ntn-UlSyncValidityDuration should neither result in system information change notifications nor in a
modification of valueTag in SIB1. ntn-UlSyncValidityDuration is only updated when at least one of epochTime, ta-Info,
ephemerisInfo is updated.
ta-Common
Network-controlled common timing advanced value and it may include any timing offset considered necessary by the
network. ta-Common with value of 0 is supported. The granularity of ta-Common is 4.072 × 10\hat{ }(−3) μs. Values are given in
unit of corresponding granularity. This field is excluded when determining changes in system information, i.e. changes of ta-
Common should neither result in system information change notifications nor in a modification of valueTag in SIB1.
ta-CommonDrift
Indicate drift rate of the common TA. The granularity of ta-CommonDrift is 0.2 × 10\hat{ }(−3) μs/s. Values are given in unit of
corresponding granularity. This field is excluded when determining changes in system information, i.e. changes of ta-
CommonDrift should neither result in system information change notifications nor in a modification of valueTag in SIB1.
ta-CommonDriftVariant
Indicate drift rate variation of the common TA. The granularity of ta-CommonDriftVariant is 0.2 × 10\hat{ }(−4) μs/s\hat{ }2. Values are
given in unit of corresponding granularity. This field is excluded when determining changes in system information, i.e.
changes of ta-CommonDriftVariant should neither result in system information change notifications nor in a modification of
valueTag in SIB1.
ta-Report
When this field is included in SIB19, it indicates reporting of timing advanced is enabled during Random Access due to RRC
connection establishment or RRC connection resume, and during RRC connection reestablishment. When this field is
included in ServingCellConfigCommon within dedicated signalling, it indicates TA reporting is enabled during Random
Access due to reconfiguration with sync (see TS 38.321 [3], clause 5.4.8).

| | |
|---|---|
| Conditional Presence | Explanation |
| SIB19 | The field is mandatory present for the serving cell in SIB19. The field is optionally |
| | present, Need R, otherwise. |

----------------------------- 38.331 V17.4.0 EXAMPLE -----------------------------

### Example 4

| | |
|---|---|
| | ----------------------------- 38.331 V17.4.0 EXAMPLE ----------------------------- |
| - | SIB19 |

SIB19 contains satellite assistance information for NTN access.

SIB19 information element

| | |
|---|---|
| -- | ASN1START |
| -- | TAG-SIB19-START |

SIB19-r17 ::= SEQUENCE {

| ntn-Config-r17 | NTN-Config-r17 | OPTIONAL, | -- Need R |
|---|---|---|---|
| t-Service-r17 | INTEGER (0..549755813887) | OPTIONAL, | -- Need R |
| referenceLocation-r17 | ReferenceLocation-r17 | OPTIONAL, | -- Need R |
| distanceThresh-r17 | INTEGER (0..65525) | OPTIONAL, | -- Need R |
| ntn-NeighCellConfigList-r17 | NTN-NeighCellConfigList-r17 | OPTIONAL, | -- Need R |
| lateNonCriticalExtension | OCTET STRING | OPTIONAL, | |
| ..., | | | |
| [[ | | | |
| ntn-NeighCellConfigListExt-v1720 | NTN-NeighCellConfigList-r17 | OPTIONAL | -- Need R |
| ]], | | | |
| [[ | | | |
| referenceLocationAltitude-r18 | INTEGER (0..32767) | OPTIONAL, | -- Need R |

]]

}

| | |
|---|---|
| NTN-NeighCellConfigList-r17 ::= | SEQUENCE (SIZE(1..maxCellNTN-r17)) OF NTN- |

NeighCellConfig-r17

| NTN-NeighCellConfig-r17 ::= | | SEQUENCE { | |
|---|---|---|---|
| | ntn-Config-r17 | NTN-Config-r17 | OPTIONAL, |
| -- | Need R | | |
| | carrierFreq-r17 | ARFCN-ValueNR | OPTIONAL, |
| -- | Need R | | |
| | physCellId-r17 | PhysCellId | OPTIONAL |

| | |
|---|---|
| -- | Need R |

}

| | |
|---|---|
| -- | TAG-SIB19-STOP |
| -- | ASN1STOP |

```
    SIB19 field descriptions
distanceThresh
Distance from the serving cell reference location and is used in location-based measurement initiation in RRC_IDLE
and RRC_INACTIVE, as defined in TS 38.304 [20]. Each step represents 50m.
ntn-Config
Provides parameters needed for the UE to access NR via NTN access such as Ephemeris data, common TA
parameters, k_offset, validity duration for UL sync information and epoch.
ntn-NeighCellConfigList, ntn-NeighCellConfigListExt
Provides a list of NTN neighbour cells including their ntn-Config, carrier frequency and PhysCellId. This set includes
all elements of ntn-NeighCellConfigList and all elements of ntn-NeighCellConfigListExt. If ntn-Config is absent for
an entry in ntn-NeighCellConfigListExt, the ntn-Config provided in the entry at the same position in ntn-
NeighCellConfigList applies. Network provides ntn-Config for the first entry of ntn-NeighCellConfigList. If the ntn-
Config is absent for any other entry in ntn-NeighCellConfigList, the ntn-Config provided in the previous entry in ntn-
NeighCellConfigList applies.
referenceLocation
Reference location of the serving cell provided via NTN quasi-Earth fixed system and is used in location-based
measurement initiation in RRC_IDLE and RRC_INACTIVE, as defined in TS 38.304 [20].
referenceLocationAltitude
The altitude of the reference locations. If signalled, the UE shall interpret referenceLocation in SIB19 and
referenceLocation1 and referenceLocation2 in condEventD1 as an EllipsoidPointWithAltitude using this field as in
37.355 [49].
t-Service
Indicates the time information on when a cell provided via NTN quasi-Earth fixed system is going to stop serving the
area it is currently covering. The field indicates a time in multiples of 10 ms after 00:00:00 on Gregorian calendar
date 1 January, 1900 (midnight between Sunday, December 31, 1899 and Monday, January 1, 1900). The exact
stop time is between the time indicated by the value of this field minus 1 and the time indicated by the value of this
field.
  ----------------------------- 38.331 V17.4.0 EXAMPLE -----------------------------
```

### Example 5

| | |
|---|---|
| | ----------------------------- 38.331 V17.4.0 EXAMPLE ----------------------------- |
| - | RRCReconfiguration |

```
  The RRCReconfiguration message is the command to modify an RRC
  connection. It may convey information
  for measurement configuration, mobility control, radio resource
  configuration (including RBs, MAC main
  configuration and physical channel configuration) and AS
  security configuration.
```

```
  Signalling radio bearer: SRB1 or SRB3
  RLC-SAP: AM
  Logical channel: DCCH
  Direction: Network to UE
```

RRCReconfiguration message

| -- | ASN1START | |
|---|---|---|
| -- | TAG-RRCRECONFIGURATION-START | |
| RRCReconfiguration ::= | | SEQUENCE { |
| | rrc-TransactionIdentifier | RRC-TransactionIdentifier, |
| | criticalExtensions | CHOICE { |
| | rrcReconfiguration | RRCReconfiguration-IEs, |
| | criticalExtensionsFuture | SEQUENCE { } |

}

}

| RRCReconfiguration-IEs ::= | | SEQUENCE { | |
|---|---|---|---|
| | radioBearerConfig | RadioBearerConfig | OPTIONAL, -- Need M |
| | secondaryCellGroup | OCTET STRING (CONTAINING | OPTIONAL, -- Cond |
| | | CellGroupConfig) | |

SCG

| | | |
|---|---|---|
| measConfig | MeasConfig | OPTIONAL, -- Need M |
| lateNonCriticalExtension | OCTET STRING | OPTIONAL, |
| nonCriticalExtension | RRCReconfiguration-v1530-IEs | OPTIONAL |

}
. . .

| RRCReconfiguration-v1800-IEs ::= | | SEQUENCE { | |
|---|---|---|---|
| | gNB-PositionCorrection-r18 | CorrectionVector-r18 | OPTIONAL, -- Need M |
| | nonCriticalExtension | SEQUENCE { } | OPTIONAL |

}

| CorrectionVector-r18 ::= | | SEQUENCE { |
|---|---|---|
| | positionX-r17 | PositionStateVector-r17, |
| | positionY-r17 | PositionStateVector-r17, |
| | positionZ-r17 | PositionStateVector-r17 |

}
. . .

| | |
|---|---|
| -- | TAG-RRCRECONFIGURATION-STOP |
| -- | ASN1STOP |

```
    RRCReconfiguration-IEs field descriptions
. . .
gNB-PositionCorrection
This field is used to correct the gNB position in an ATG network for
synchronization purposes. The correction
vector is subtracted from the broadcasted position. This field is only
configured when AS security has been
established.
. . .
  ----------------------------- 38.331 V17.4.0 EXAMPLE -----------------------------
```

It will be appreciated that examples of the present disclosure may be realized in the form of hardware, software or a combination of hardware and software. Certain examples of the present disclosure may provide a computer program comprising instructions or code which, when executed, implement a method, system and/or apparatus in accordance with any aspect, example and/or embodiment disclosed herein. Certain embodiments of the present disclosure provide a machine-readable storage storing such a program.

FIG. 11 is a block diagram of an exemplary network entity/function that may be used in examples of the present disclosure, such as the techniques disclosed in relation to any of the preceding figures. For example, any of the network entities, network function etc. (e.g. UE, BS, gNB/eNB, ATG entities) may be provided in the form of the network entity illustrated in FIG. 11. The skilled person will appreciate that a network entity/function may be implemented, for example, as a network element on a dedicated hardware, as a software instance running on a dedicated hardware, and/or as a virtualised function instantiated on an appropriate platform, e.g. on a cloud infrastructure.

The entity 1100 comprises a processor (or controller) 1101, a transmitter 1103 and a receiver 1105. The receiver 1105 is configured for receiving one or more messages from one or more other network entities, for example as described above. The transmitter 1103 is configured for transmitting one or more messages to one or more other network entities, for example as described above. The processor 1101 is configured for performing one or more operations, for example according to the operations as described above.

It will be appreciated that, in each example/embodiment/aspect etc. described above, one or more features or operations may be omitted, modified or moved (e.g., to change the order of the features or the operations), if desired and appropriate.

Additionally, where the figures illustrating example method flows include text in relation to a specific step/operation, it will be appreciated that this text is simply an example of the corresponding step/operation, where a more general definition (such as may be found in the description of the corresponding step) may apply for the step/operation.

Additionally, regarding all of the above, one or more features or operations etc. from any example/embodiment may be combined with features or operations from any other example/embodiment. That is, the present disclosure should be considered to include all combinations of examples/embodiments disclosed herein, as appropriate, as well as combinations of individual features within and between each example/embodiment, as appropriate.

The techniques described herein may be implemented using any suitably configured apparatus and/or system. Such an apparatus and/or system may be configured to perform a method according to any aspect, embodiment or example disclosed herein. Such an apparatus may comprise one or more elements, for example one or more of receivers, transmitters, transceivers, processors, controllers, modules, units, and the like, each element configured to perform one or more corresponding processes, operations and/or method steps for implementing the techniques described herein. For example, an operation/function of X may be performed by a module configured to perform X (or an X-module). The one or more elements may be implemented in the form of hardware, software, or any combination of hardware and software.

It will be appreciated that examples of the present disclosure may be implemented in the form of hardware, software or any combination of hardware and software. Any such software may be stored in the form of volatile or non-volatile storage, for example a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like.

It will be appreciated that the storage devices and storage media are embodiments of machine-readable storage that are suitable for storing a program or programs comprising instructions that, when executed, implement certain examples of the present disclosure. Accordingly, certain examples provide a program comprising code for implementing a method, apparatus or system according to any example, embodiment and/or aspect disclosed herein, and/or a machine-readable storage storing such a program. Still further, such programs may be conveyed electronically via any medium, for example a communication signal carried over a wired or wireless connection.

While the disclosure has been shown and described with reference to certain examples, it will be understood by those skilled in the art that various changes in form and detail may be made therein without departing from the scope of the disclosure.

The reader's attention is directed to all papers and documents which are filed concurrently with or previous to this specification in connection with this application and which are open to public inspection with this specification, and the contents of all such papers and documents are incorporated herein by reference.

### ACRONYMS AND DEFINITIONS

3GPP 3rd Generation Partnership Project
5G 5th Generation
5GC 5G Core
5QI 5G QoS Identifier
5GS 5G System
5GSM 5G System Session Management
5GMM 5G System Mobility Management
AF Application Function
AI Artificial Intelligence
AM Acknowledged Mode
AMF Access and Mobility Management Function
AS Access Stratum
ASP Application Service Provider
ATG Air-To-Ground
AUSF Authentication Server Function
CDN Content Delivery Network
DCAF Data Collection Application Function
DNAI Data Network Access Identifier
DNN Data Network Name
DNS Domain Name Server
DRB Data Radio Bearer
eNB Evolved Node B
EPC Evolved Packet Core
FEC Forward Error Correction
FQDN Fully Qualified Domain Name
GBR Guaranteed Bit Rate
gNB Next generation Node B
GPSI Generic Public Subscription Identifier
HSS Home Subscriber Service
IAB Integrated Access and Backhaul
ID Identity/Identifier
IIoT Industrial Internet of Things
IMEI International Mobile Equipment Identities
IP Internet Protocol
I-SMF Intermediate SMF
LADN Local Area Data Network
LL SSM Lower Layer SSM
MBMS Multimedia Broadcast/Multicast Service
MBS Multicast/Broadcast Service
MBSF Multicast/Broadcast Service Function
MBSTF Multicast/Broadcast Service Transport Function
MB-SMF Multicast/Broadcast Session Management Function
MB-UPF Multicast/Broadcast User Plane Function
ML Machine Learning
MME Mobility Management Entity
MN Master Node
MNF Monitoring Network Function
MNO Mobile Network Operator
MT Mobile Termination
NAS Non-Access Stratum
NEF Network Exposure Function
NRF Network Repository Function
NG-RAN Next Generation Radio Access Network
NG-eNB Next Generation eNB
NSA Non-Standalone
NSSF Network Slice Selection Function
NTN Non-Terrestrial Networks
NW Network
NWDAF Network Data Analytics Function
OS Operating System
OSAPP OS Application
PCF Policy Control Function
PCO Protocol Configuration Options
PDR Packet Detection Rule
PDU Protocol Data Unit
PTM Point To Multipoint
PTP Point to Point
QFI QoS Flow Identifier (ID)
QoS Quality of Service
RACH Random Access Channel
RAN Radio Access Network
RRC Radio Resource Control
RSD Route Selection Descriptor
SA Standalone
SDAP Service Data Adaptation Protocol
SDU Service Data Unit
SGW Serving Gateway
SIM Subscriber Identity Module
SLA Service Level Agreement
SM Session Management
SMF Session Management Function
SN Secondary Node
S-NSSAI Single Network Slice Selection Assistance Information
SSB Synchronization Signal Block
SSM Source Specific IP Multicast address
SSC Session and Service Continuity
SRB Signaling Radio Bearer
SUPI Subscription Permanent Identifier
TA Tracking Area
TAI Tracking Area Identity
TE Terminal Equipment
TM Transparent Mode
TMGI Temporary Mobile Group Identity
TS Technical Specification
UAV Unmanned Aerial Vehicle
UDM Unified Data Manager
UDR Unified Data Repository
UE User Equipment
UL Uplink
UM Unacknowledged Mode
UP User Plane
UPF User Plane Function
URLLC Ultra-Reliable and Low-Latency Communication
URSP UE Route Selection Policy

1. A method performed by a user equipment (UE) in a wireless communication system, the method comprising:
receiving, from a base station, a system information message including at least one system information block (SIB); and
identifying an air-to-ground (ATG) configuration based on an SIB of the at least one SIB; and
performing an ATG access procedure based on the ATG configuration.

2. The method of claim 1,
wherein the ATG configuration includes a height of the base station for the ATG access procedure.

3. The method of claim 1,
wherein the ATG configuration includes a location of the base station for the ATG access procedure.

4. The method of claim 1, further comprising:
determining a position of the UE based on the ATG configuration.

5. A method performed by a base station in a wireless communication system, the method comprising:
identifying an air-to-ground (ATG) configuration based on a system information block (SIB); and
transmitting, to a user equipment (UE), a system information message including the SIB;
wherein an ATG access procedure is performed based on the ATG configuration.

6. The method of claim 5,
wherein the ATG configuration includes a height of the base station for the ATG access procedure.

7. The method of claim 5,
wherein the ATG configuration includes a location of the base station for the ATG access procedure.

8. The method of claim 5,
wherein a position of the UE is determined based on the ATG configuration.

9. A user equipment (UE) in a wireless communication system, the UE comprising:
a transceiver; and
a controller coupled with the transceiver configured to:
receive, from a base station, a system information message including at least one system information block (SIB); and
identify an air-to-ground (ATG) configuration based on an SIB of the at least one SIB; and
perform an ATG access procedure based on the ATG configuration.

10. The UE of claim 9,
wherein the ATG configuration includes a height of the base station for the ATG access procedure.

11. The UE of claim 9,
wherein the ATG configuration includes a location of the base station for the ATG access procedure.

12. The UE of claim 9, wherein the controller is further configured to:
determine a position of the UE based on the ATG configuration.

13. A base station in a wireless communication system, the base station comprising:
a transceiver; and
a controller coupled with the transceiver configured to:
identify an air-to-ground (ATG) configuration based on a system information block (SIB); and
transmit, to a user equipment (UE), a system information message including the SIB;
wherein an ATG access procedure is performed based on the ATG configuration.

14. The base station of claim 13,
wherein the ATG configuration includes a height of the base station for the ATG access procedure.

15. The base station of claim 13,
wherein the ATG configuration includes a location of the base station for the ATG access procedure, and
wherein a position of the UE is determined based on the ATG configuration.
